(19) United States
(12) Patent Application Publication
(10) Pub. No.: US 2019/0213679 A1
(43) Pub. Date: Jul. 11, 2019

(54) SYSTEM TO EFFECT CROSS-BORDER PAYMENT

(71) Applicant: MASTERCARD INTERNATIONAL INCORPORATED, Purchase, NY (US)

(72) Inventors: Bharathi R., Chennai (IN); Ashutosh Sharan, Gurgaon (IN); Akash Bansal, Gurgaon (IN); Navneet Kumar, Varanasi (IN)

(73) Assignee: MASTERCARD INTERNATIONAL INCORPORATED, Purchase, NY (US)

(21) Appl. No.: 16/236,943

(22) Filed: Dec. 31, 2018

(30) Foreign Application Priority Data
Jan. 11, 2018 (SG) 10201800278R

(51) Int. Cl. G06Q 40/04; G06Q 20/10

(52) U.S. Cl. CPC G06Q 40/04; G06Q 20/10

(57) ABSTRACT

According to a first aspect, there is provided a cross-border payment server comprising: at least one processor; at least one memory including computer program code; the at least one memory and the computer program code configured to, with the at least one processor, cause the cross-border payment server at least to: that receive, from an account, an indication of a fund amount to finance cross-border transactions; calculate assets purchased by the fund amount; supply the account with the purchased assets; update the assets held in the account resulting from assets traded during each cross-border transaction involving the account; and effect a return of funds in response to sale of the assets held in the account.

### TECHNICAL FIELD

The following discloses a system that facilitates cross-border payment.

### BACKGROUND

According to a global payments 2016 report by McKinsey & Company Global, the global payments industry is estimated to generate $2.2 trillion in revenue by 2020.

With such growth, existing problems for global payment, such as the time taken to validate a cross-border transaction and the high processing cost of a cross-border payment will also commensurately worsen.

The present disclosure provides a transparent model that seeks to improve cross-border payment and also hasten real time settlement of a cross-border payment. Other desirable features and characteristics will become apparent from the subsequent detailed description and the appended claims, taken in conjunction with the accompanying drawings.

### SUMMARY OF THE INVENTION

According to a first aspect, there is provided a cross-border payment server comprising: at least one processor; at least one memory including computer program code; the at least one memory and the computer program code configured to, with the at least one processor, cause the cross-border payment server at least to: that receive, from an account, an indication of a fund amount to finance cross-border transactions; calculate assets purchased by the fund amount; supply the account with the purchased assets; update the assets held in the account resulting from assets traded during each cross-border transaction involving the account; and effect a return of funds in response to sale of the assets held in the account.

According to a second aspect, there is provided a method to effect cross-border payment, the method comprising: receiving, from an account, an indication of a fund amount to finance cross-border transactions; calculating assets purchased by the fund amount; supplying the account with the purchased assets; updating the assets held in the account resulting from assets traded during each cross-border transaction involving the account; and effecting a return of funds in response to sale of the assets held in the account.

According to a third aspect, there is provided a non-transitory computer readable medium for storing a program that when installed into a computer device configures the computer device to receive, from an account, an indication of a fund amount to finance cross-border transactions; calculate assets purchased by the fund amount; supply the account with the purchased assets; update the assets held in the account resulting from assets traded during each cross-border transaction involving the account; and effect a return of funds in response to sale of the assets held in the account.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to illustrate various embodiments and to explain various principles and advantages in accordance with a present embodiment, by way of non-limiting example only.

Embodiments of the invention are described hereinafter with reference to the following drawings, in which:

FIG. 1 shows a schematic of a system which supports cross-border payment in accordance with various embodiments of the present invention.

FIG. 2 shows a sequence of steps that occur in a merchant bank and a purchaser bank of the system of FIG. 1 to realize cross-border payment.

FIG. 3 shows a sequence of steps that occur for a buyer and a seller during the cross-border payment.

FIG. 4 shows a flow chart of a sequence of steps that occurs when a cross-border transaction is performed using the system of FIG. 1.

FIG. 5 shows data fields provided in a graphic user interface maintained by a purchaser bank of FIG. 1, through which a buyer 112 can enter details of the cross-border transaction.

FIG. 6 shows a feedback screen which can be used to rate the cross-border payment facility provided by the system of FIG. 1.

FIG. 7 shows an account summary page which displays a history of cross-border payments that a buyer 112 has made using their buyer bank account.

FIG. 8 shows a flow chart of a sequence of steps that occurs at the start of a business trading cycle and a flow chart of a sequence of steps that occurs at the end of a business trading cycle.

FIG. 9 shows a schematic of a flow of funds in the system of FIG. 1 during the end of a business trading cycle.

FIG. 10 provides a schematic diagram of functional modules present in a cross-border payment server of the system of FIG. 1.

FIG. 11 is a schematic of a computing device used to implement the cross-border payment server shown in FIG. 1.

### DETAILED DESCRIPTION

### Overview

Various embodiments of present disclosure provide a method and a system that facilitates cross-border payment, which is a purchase made in a currency that is not the same as that used by a banking account selected to fund the purchase. For example, a credit card linked to a Thai bank account, denominated in Thai Baht, can be used to purchase goods from a merchant located in the US, where the transaction is done in US dollar. The cross-border transaction does not necessarily have to occur over a geographical border (such as when a US tourist purchases goods from a local merchant in Vietnam using his credit card issued in the US), but applies for transactions that occur across a geographical border (such as when a customer uses his Singapore issued credit card for an online purchase of goods from a US based merchant on an ecommerce website).

One of the problems faced in cross-border transactions is the risk of an unrealized gain or an unsettled trade because of default prior to settlement. This risk is reduced by compressing the settlement interval, that is, the amount of time between the execution of a trade and its settlement, but is eliminated only by settling trades in real time as they are executed. Embodiments of the present disclosure provide such real time settlement by using points (instead of cash) as a medium for payment in a cross-border payment, along with a server (hereafter referred to as a “cross-border payment server”) to manage the circulation of the points. When a cross-border transaction is supported by a cross-border payment server in accordance with various embodiments of the present disclosure, points having an equivalent value to the cost of the cross-border transaction are traded between parties (e.g. a purchaser and a merchant providing a good or a service) of the cross-border transaction. A payment is considered made when an account registered to the purchaser is debited an amount of points and the points credited into an account registered to the merchant, less a transaction fee, if any. The cross-border transacting parties honor settlements using these points because they are guaranteed from being backed by currency or funds reserved in a designated financial institution, whereby the points are convertible into these reserved currency or funds upon request or at the end of a business trading cycle. The currency or funds backed points are thus also referred to as assets in the present disclosure, since they have a guaranteed value.

The supplier of these assets or points typically guarantees their value, whereby the funds used to purchase the assets are stored in one or more financial institutions designated by the supplier. The one or more designated financial institutions thus act as a repository for the funds that are underlying the traded assets. The supplier also maintains a ledger for each of the accounts of cross-border transacting parties. Each ledger account is updated as assets are used to make payment for purchases or when assets are received from received payment. When a ledger account is credited with assets, the bank to which the account belongs can safely pay the beneficiary (usually a merchant providing a good or a service) of the transaction a cash amount that is equivalent to the credited assets in respect of that transaction, due to the above mentioned currency or funds backing. In one implementation, each ledger account is credited with an amount of assets that are purchased at a start of a business trading cycle, whereby the funds used for the purchase are stored in the designated one or more financial institutions. At an end of the business trading cycle, any remaining assets are then repurchased by the supplier using the funds stored in the designated one or more financial institutions. The supplier also maintains a platform over which the assets are traded between the cross-border transacting parties.

### Terms Description (In Addition to Dictionary Meaning of Terms)

A cross-border payment server refers to a system comprising one or more server terminals that is used to host a platform that can facilitate the trading of assets used as a medium for payment in a cross-border transaction, i.e. the assets are transferred between accounts of parties to a transaction with each banking in a different local currency. For instance, an account registered to the purchaser may use Singapore dollars, while an account registered to the merchant may use US dollars. When a cross-border transaction is performed between a purchaser bank and a merchant bank, the platform is notified at the settlement stage where the platform executes instructions that cause the cross-border payment server to effect payment from the purchaser bank to the merchant bank, whereby assets are transferred from the account registered to the purchaser bank and the account registered to the merchant bank.

A cross-border transaction refers to a sequence of steps starting from a selection of a good or service provided by a merchant; an indication of a bank used to fund the selected good or service (i.e. the identification of a purchaser bank to the cross-border payment server); the cross-border payment that the cross-border payment server effects through the transfer of assets from an account registered to the purchaser bank to an account registered to the merchant bank; and the claw back of funds into the purchaser bank and the merchant bank from sale of assets that remain in the respective accounts maintained by the cross-border payment server.

The meaning of account depends on the context. An account in the cross-border payment server refers to a record, kept in a ledger maintained by the cross-border payment server, which is created when a party (e.g. a purchaser bank or a merchant bank) registers to utilize the cross-border payment service provided by the cross-border payment server. In the present disclosure, the account registered to the purchaser bank is called a purchaser ledger account, while the account registered to the merchant bank is called a merchant ledger account. The purchaser ledger account and the merchant ledger account are also used to keep track of assets that the purchaser bank and the merchant bank purchases, along with those that are credited or debited during a cross-border payment. It is also through their respective ledger account that the purchaser bank or the merchant bank accesses the facilities provided by the cross-border payment server, such as effecting of cross-border payment, purchase of assets and sale of assets. An account in the purchaser bank refers to one which is opened by a party wishing to use the banking facilities of the purchaser bank, such as to send funds used to make purchases from a merchant. This account is called the buyer bank account. Similarly, an account in the merchant bank refers to one which is opened by a party wishing to use the banking facilities of the merchant bank, such as to receive funds from sold purchases. This account is called the seller bank account.

An indication of a fund amount refers to an amount of funds that an account registered with the cross-border payment server puts up for purchasing assets used by the cross-border payment server in cross-border payment. This leads to an equivalent volume of assets being supplied to the purchaser ledger account and the merchant ledger account.

Assets refer to a medium for payment in a cross-border transaction, with the circulation of the assets being managed by the cross-border payment server.

Supply of an account with purchased assets refers to the provisioning of either the purchaser ledger account or the merchant ledger account with a volume of assets resulting from the amount of funds used for their purchase.

Effecting the return of funds into the account refers to the cross-border payment server channeling funds, stored in one or more designated financial institutions, to the purchaser bank or the merchant bank via their respective ledger accounts maintained by the cross-border payment server.

### Exemplary Embodiments

Embodiments of the present invention will be described, by way of example only, with reference to the drawings. Like reference numerals and characters in the drawings refer to like elements or equivalents.

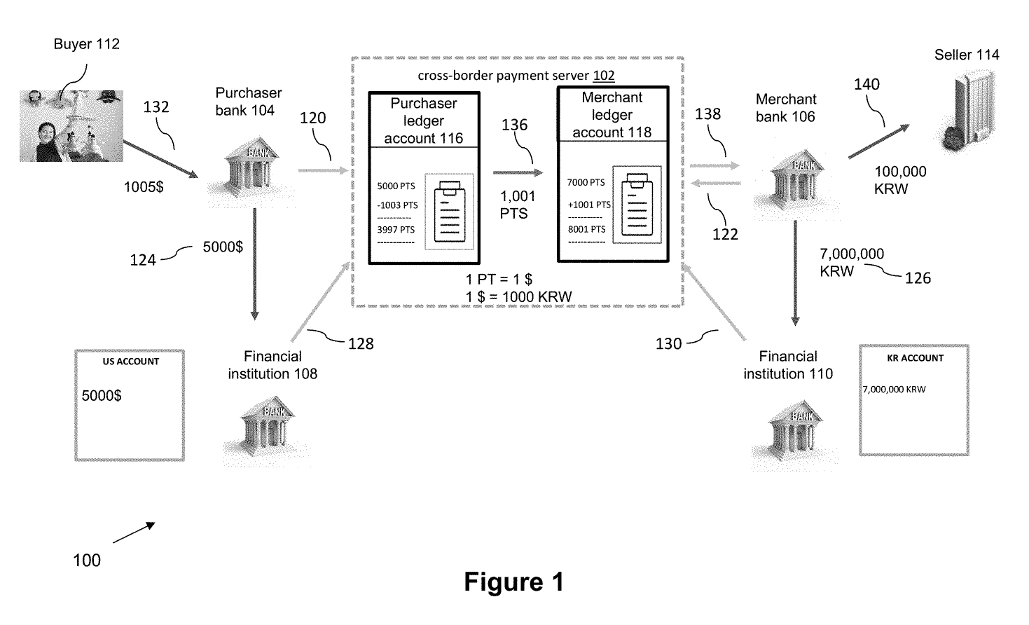

FIG. 1 shows a schematic of a system 100 which supports cross-border payment in accordance with various embodiments of the present invention. The system 100 includes a cross-border payment server 102 which is in communication with a purchaser bank 104, a merchant bank 106, financial institutions 108 and 110. The purchaser bank 104 is in turn in communication with a buyer 112, while the merchant bank 106 is in communication with a seller 114. The purchaser bank 104, the financial institution 108 and the buyer 112 are geographically located a territory that is different from that in which the merchant bank 106, the financial institution 110 and the seller 114 are located. Accordingly, the currency that the purchaser bank 104, the financial institution 108 and the buyer 112 uses is different from the currency that the merchant bank 106, the financial institution 110 and the seller 114 uses.

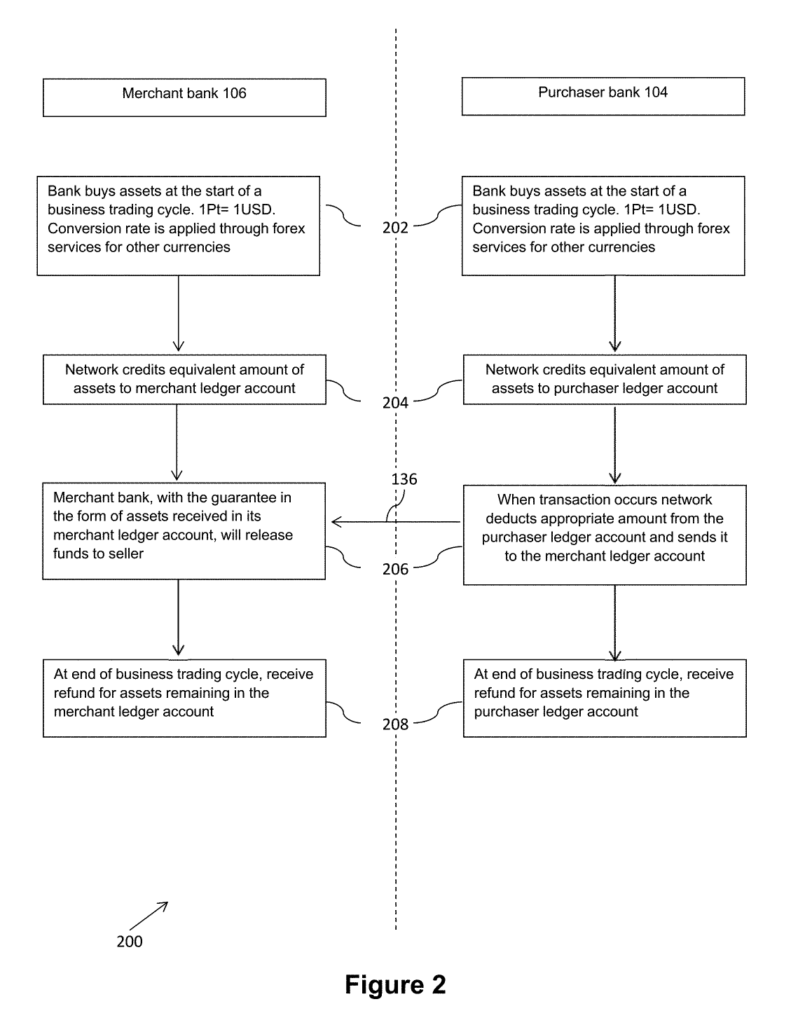

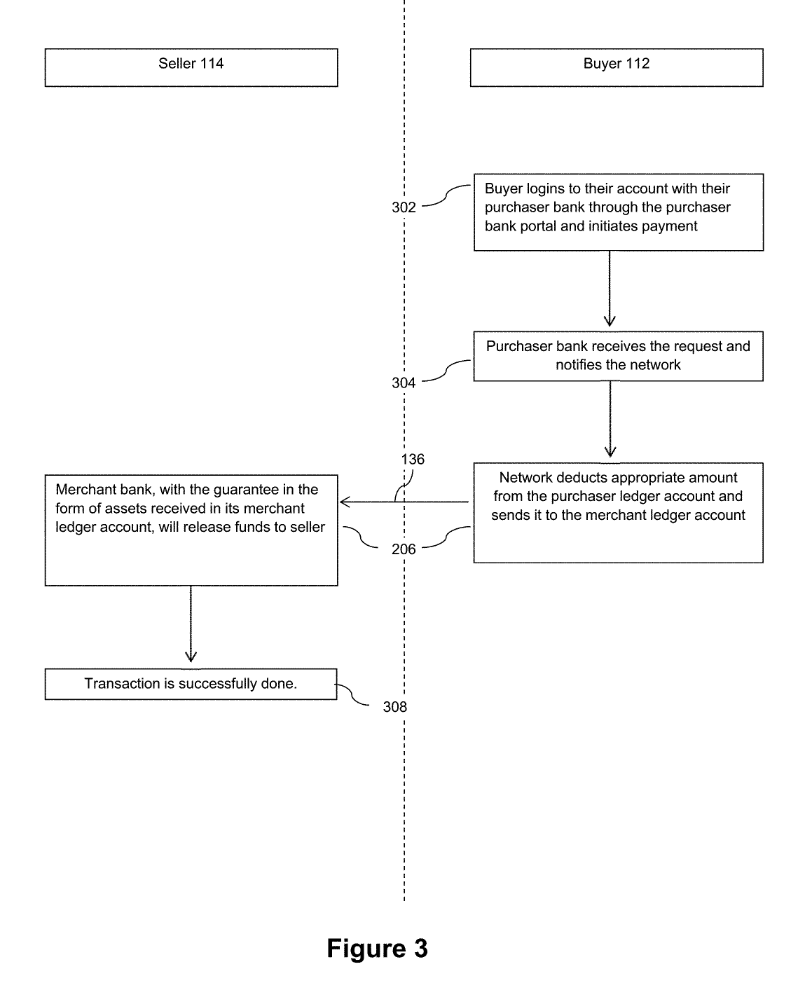

The purchaser bank 104 is so called because it holds the buyer's 112 funds that are used to make a purchase for a good or service provided by the seller 114. Similarly, the merchant bank 106 is so called because it receives the funds for the purchase of a good or service provided by the seller 114. When the buyer 112 wishes to purchase a good or service provided by the seller 114, funds from the buyer's 112 account with the purchaser bank 104 (hereafter called “the buyer bank account”) have to reach the seller's account with the merchant bank 106 (hereafter called “the seller bank account”). The cross-border payment server 102 provides a platform which allows for the cross-border payment from the purchaser bank 104 to the merchant bank 106. Cross-border payment, in accordance with one implementation, is described in further detail below with reference to FIGS. 2 and 3.

To utilize the cross-border payment facility provided by the cross-border payment server 102, each of the purchaser bank 104 and the merchant bank 106 registers an account with the cross-border payment server 102. The account that the purchaser bank 104 registers with the cross-border payment server 102 is called the purchaser ledger account 116, while the account that the merchant bank 106 registers with the cross-border payment server 102 is called the merchant ledger account 118. As mentioned above, the system 100 uses assets as a medium for cross-border payment, whereby the purchaser ledger account 116 keeps a record of the assets that the purchaser bank 104 has with the cross-border payment server 102, while the merchant ledger account 118 keeps a record of the assets that the merchant bank 106 has with the cross-border payment server 102.

At the start of a business trading cycle, the purchaser ledger account 116 and the merchant ledger account 118 will have no stored assets. The purchaser bank 104 will communicate 120 an order to purchase a volume of assets from the cross-border payment server 102. The amount that the purchaser bank 104 decides to purchase is, in one approach, determined from forecasting based on predictive analytics, such as averaging the volume of assets traded over a past period. As an added precaution, a buffer (such as 5-15%) may be applied on the average determined over the selected period, wherein the buffer is only utilized after the average is depleted. This buffer serves to address a scenario where a business trading cycle exceeds expected daily usage. If the purchaser bank 104 is using a currency that is different from the one in which the assets are based, the cross-border payment server 102 will apply a foreign exchange rate that is available, for example, from a portal hosting currency exchange pair rates.

Similarly, the merchant bank 106 will communicate 122 an order to purchase a volume of assets from the cross-border payment server 102. It will be appreciated that while the merchant bank 106 does not require assets to be held in its merchant ledger account 118 to receive assets resulting from payment of a good or service provided by the seller 114, the merchant bank 106 also acts as a funds source when it receives an instruction to make payment to another merchant bank (not shown). Thus, the merchant bank 106 also requires assets to be held in its merchant ledger account 118 with the cross-border payment server 102. The amount that the merchant bank 106 decides to purchase is, in one approach, determined from forecasting based on predictive analytics, such as averaging the volume of assets traded over a past period. As an added precaution, a buffer (such as 5-15%) may be applied on the average determined over the selected period, wherein the buffer is only utilized after the average is depleted. This buffer serves to address a scenario where a business trading cycle exceeds expected daily usage. If the merchant bank 106 is using a currency that is different from the one in which the assets are based, the cross-border payment server 102 will apply a foreign exchange rate that is available, for example, from a portal hosting currency exchange pair rates.

The order for assets will be conveyed through the purchaser ledger account 116 and the merchant ledger account 118, so that the cross-border payment server 1102 will receive an indication of a fund amount used to finance cross-border transactions. This purchase of assets from the purchaser bank 104 and the merchant bank 106 is shown as step 202 of the flow chart 200 shown in FIG. 2.

The funds 124, 126 that are used to purchase the assets are deposited into a respective financial institution 108, 110. Each of these financial institutions 108, 110 are banks that are designated by the cross-border payment server 102 as local repositories to hold the funds used for the assets purchase, i.e. the designated financial institution 108, 110 operates in the same territory as the purchaser bank 104 and the merchant bank 106. Thus, in the case of the purchaser bank 104, the funds 124 are deposited in the financial institution 108, while in the case of the merchant bank 106, the funds 126 are deposited in the financial institution 110. The financial institutions 108, 110 send a respective notification 128, 130 to the cross-border payment server 102 once the funds 124, 126 are deposited.

Upon receipt of the notification 128, 130 of the funds 124, 126 having been deposited, the cross-border payment server 102 calculates the assets that are purchased by the funds 124, 126. The purchased assets are supplied to the purchaser ledger account 116 and the merchant ledger account 118. In the example shown in FIG. 1, the asset is based on US dollars (USD), so that the purchaser ledger account 116 is awarded 5,000 points for the funds 124 payment of USD 5,000. The purchaser ledger account 116 is awarded 7,000 points for the funds payment of 7,000,000 KRW (Korean Won), at an exchange rate of 1,000 KRW: 1 USD. The crediting of assets into the purchaser ledger account 116 and the merchant ledger account 118 is shown as step 204 of the flow chart 200 shown in FIG. 2.

With assets being held in both the purchaser ledger account 116 and the merchant ledger account 118, these accounts 116 and 118 are now utilisable to effect cross-border payment. With reference to step 302 of FIG. 3, the buyer 112 logs into their buyer bank account with the purchaser bank 104 so as to initiate payment 132 from the purchaser bank 104 to the merchant bank 106. In the example shown in FIG. 1, the cost of the good or service provided by the seller 114 is USD 1,000. However, due to processing charges imposed by both the purchaser bank 104 and the cross-border payment server 102 (for a total processing fee of USD 5 in the example shown in FIG. 1), a request to initiate the payment will result in a sum of USD 1,005 to be deducted from the buyer bank account. In the example shown in FIG. 1, the purchaser bank 104 imposes a processing fee of USD 2 when imitating the payment.

In step 304 of FIG. 3, the purchaser bank 104 receives the request and notifies 120 the cross-border payment server 102 to effect the cross-border payment. The cross-border payment server 102 is configured to keep a percentage of assets traded during each cross-border transaction in the form of a processing fee that is charged in assets. Accordingly, in step 206 of both FIGS. 2 and 3, the cross-border payment server 102 will deduct a volume of assets from the purchaser ledger account 116 that covers the cost of the purchase and its processing fee. The assets that are credited 136 to the merchant ledger account 118 are less the processing fee imposed by the cross-border payment server 102. In the example shown in FIG. 1, the processing fee that the cross-border payment server 102 imposes is 2 asset points. The processing fee is borne by the purchaser ledger account 116 since the purchaser ledger account 116 is debited 1,003 asset points while the merchant ledger account 118 is credited 1,001 asset points (i.e. 1,003 asset points less the 2 asset points processing fee).

The cross-border payment server 102 is configured to update the assets held in the accounts involved in the cross-border transactions when assets are traded. Thus, in the case of the asset trade between the purchaser ledger account 116 and the merchant ledger account 118, the 1,003 asset points is deducted from the initially held 5,000 asset points to result in a new balance of 3,997 asset points in the purchaser ledger account 116. The 1,001 asset points is credited into the initially held 7,000 asset points to result in a new balance of 8,001 asset points in the merchant ledger account 118.

The merchant bank 106 is notified 138 by the cross-border payment server 102 that its merchant ledger account 118 is credited with the assets from the cross-border payment in step 206 of both FIGS. 2 and 3. Since the assets are backed by funds deposited in the financial institution 110, the merchant bank 106 is able to immediately release 140 funds to the seller 114 of an amount that is equivalent to the assets credited in the merchant ledger account 118, less a processing fee imposed by the merchant bank 106 (which is one asset point in the example shown in FIG. 1). With the seller 114 receiving the payment of 100,000 KRW (equivalent to USD 1,000 at the exchange rate of 1,000 KRW: 1 USD), the cross-border transaction is considered completed, as shown in step 306 of FIG. 3.

The purchaser bank 104 and the merchant bank 106 have their funds held in the form of assets in the purchaser ledger account 116 and the merchant ledger account 118 respectively returned when these held assets are sold. Such a sale occurs at the end of a business trading cycle, when a balance of the assets remaining in the purchaser ledger account 116 and the merchant ledger account 118 are refunded, i.e. purchased back by the cross-border payment server 102. This results in a return of funds to the purchaser bank 104 and the merchant bank 106 respectively, as shown in step 208 of FIG. 2. The source of the funds for the refund to the purchaser bank 104 is the financial institution 108, while the source of the funds for the refund to the merchant bank 106 is the financial institution 110. The refund is channeled through the purchaser ledger account 116 and the merchant ledger account 118 respectively. In one implementation, the settlement of the purchaser ledger account 116 and the merchant ledger account 118 are timed to occur at a common shutdown period for all geographies, such as 2200 h to 2400 h US time, which corresponds to 0830 h to 1030 h India time. All transfers will be disabled during this shutdown window. Alternatively, the return of funds is effected in response to the purchaser bank 104 and the merchant bank 106 making a request through their respective purchaser ledger account 116 and merchant ledger account 118 that their held assets be sold.

In the scenario where the financial institution 108, 110 do not have enough funds to purchase the assets remaining in the purchaser ledger account 116 and the merchant ledger account 118 respectively, the financial institution 108, 110 obtains, in one possible approach, the shortfall from another financial institution (not shown) that is in communication with the cross-border payment server 102.

It will be appreciated that the ledger maintained by the cross-border payment server 102 maintains accounts for all banks that have registered with the cross-border payment server 102, which include the purchaser bank 104 and the merchant bank 106. With the cross-border payment server 102 routing assets between onboarded banks, the ledger therefore serves as a book record of all cross-border transactions that the cross-border payment server 102 facilitates. The balance of the assets held in each registered bank account is updated each time the account is a party to a cross-border transaction. In one implementation, the system 100 is a permissioned block chain. The majority of the nodes of the block chain belong to the cross-border payment server 102, with each of the banks constituting a node of the block chain. The ledger maintained by the cross-border payment server 102 is distributed across all banks within the system 100 to which the cross-border payment server 102 belongs. When each bank has an update to enter into its respective ledger account, the bank accesses the ledger at a respective distribution node to provide notification of the update. The notification is then transmitted to the cross-border payment server 102 from that distribution node. In this manner, the cross-border payment server 102 receives a notification transmitted within the system 100 that a balance of assets held in the ledger account belonging to the bank is to be updated. Accordingly, the ledger maintained by the cross-border payment server 102 is permissioned in that each bank can initiate for the ledger to be updated, but changes to the ledger can only be performed by the cross-border payment server 102 since it is the majority node holder.

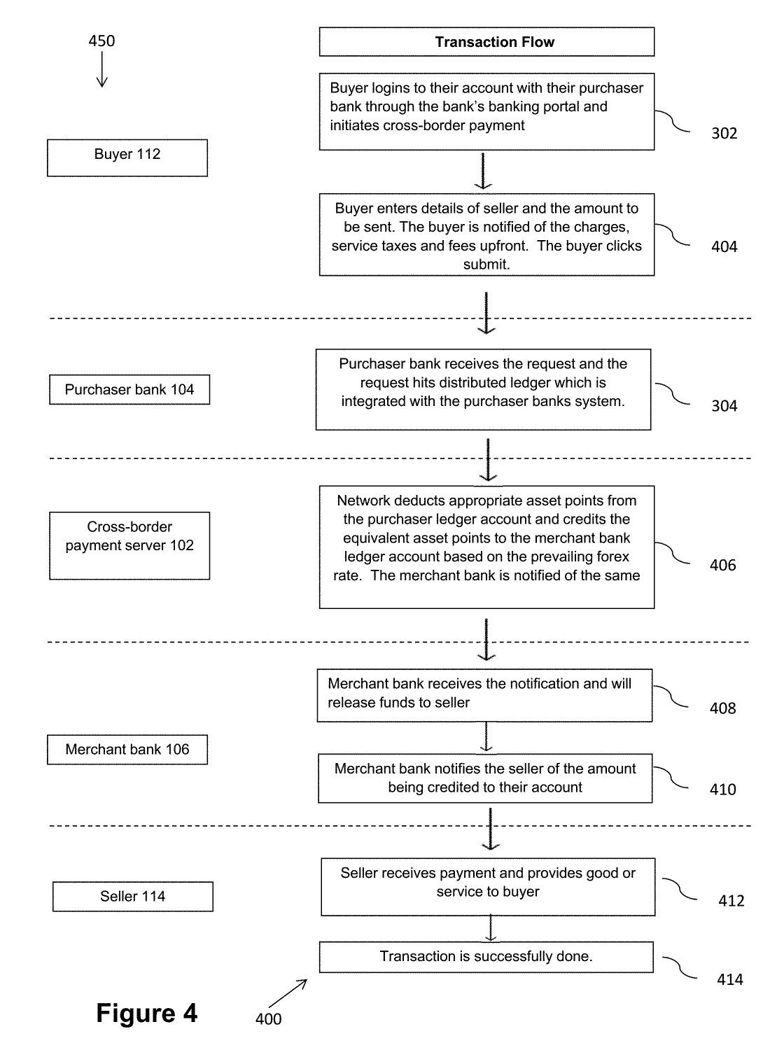

FIG. 4 shows a flow chart 400 of a sequence of steps that occurs when a cross-border transaction is performed using the system 100 of FIG. 1. The column 450 on the left of the flow chart 400 indicates the corresponding steps of the flow chart 400 for which a component of the system 100 is responsible. FIG. 4 is discussed in detail below with reference to the description in respect of FIG. 1.

As explained above, in step 302 of FIG. 3, the buyer 112 logs into their buyer bank account with the purchaser bank 104 so as to initiate payment 132 from the purchaser bank 104 to the merchant bank 106. The buyer 112 does so through a web portal maintained by the purchaser bank 104.

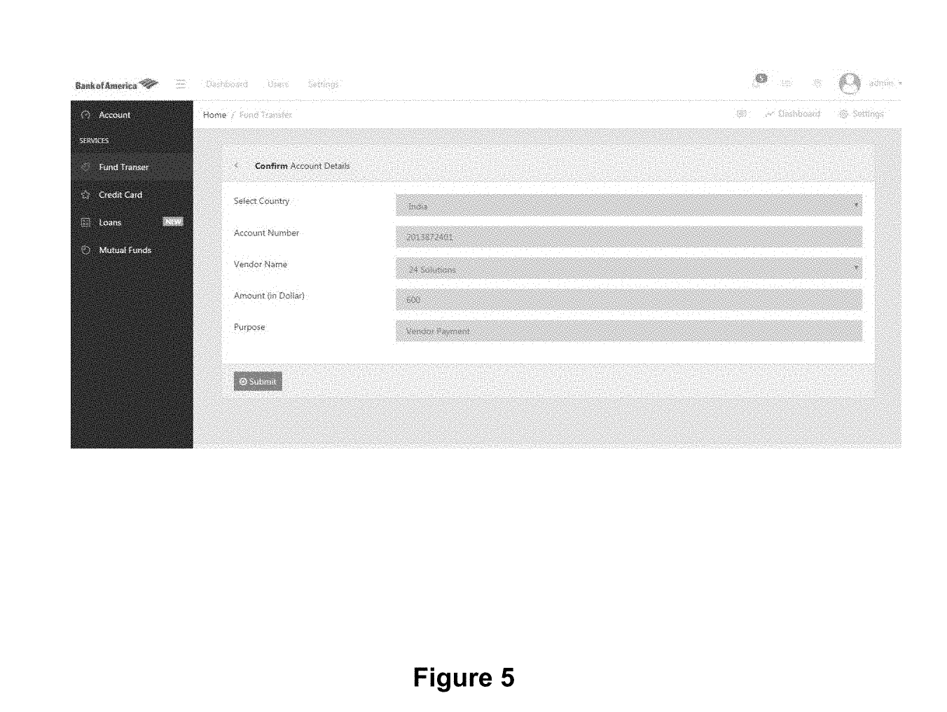

The web portal provides a user interface (see FIGS. 5 to 7) through which the buyer 112 can provide details of the seller 1134 and the amount of funds to be sent. The provision of such details is performed in step 404. The buyer 112 is notified of the cost, service taxes and processing charges upfront. Step 404 ends when the buyer 112 clicks submit, for the purchaser bank 104 to process their request to proceed with cross-border payment.

The purchaser bank 104 receives the request in step 304 and notifies 134 the cross-border payment server 102 to effect the cross-border payment. In one implementation, the purchaser bank 104 notifies 134 the cross-border payment server 102 about the request, so that the cross-border payment server 102 can initiate the necessary debiting of assets from the purchaser ledger account 116 and the crediting of assets into the merchant ledger account 118. In another implementation, the ledger that is maintained by the cross-border payment server 102 is also integrated into a ledger of the purchaser bank 104 system. The, request will be processed by the purchaser bank 104 ledger, which routes the request to the ledger maintained by the cross-border payment server 102. In this other implementation, the purchaser bank 104 systems also keeps its own records of purchased assets that are being circulated in the system 100.

Steps 406, 408, 410 and 412 are sub-steps of the step 206 described with respect to FIGS. 2 and 3.

In the step 406, the purchaser ledger account 116 is debited a volume of asset points, while the merchant ledger account 118 is credited 136 the volume of asset points deducted from the purchaser ledger account 116. The cross-border payment server 102 notifies the merchant bank 106 after the merchant ledger account 118 is updated.

The merchant bank 106 receives the notification in step 408 and releases to the seller 114 funds of monetary value that is equivalent to the asset points credited into its merchant ledger account 118. These funds are credited into the seller bank account that the seller 114 has with the merchant bank 106. In step 410, the merchant bank 106 informs the seller 114 of the funds having been credited into their seller bank account.

Upon confirmation of the receipt of the credited funds in step 412, the seller 114 provides the good or service that the buyer 112 has purchased. The cross-border transaction then ends in step 414.

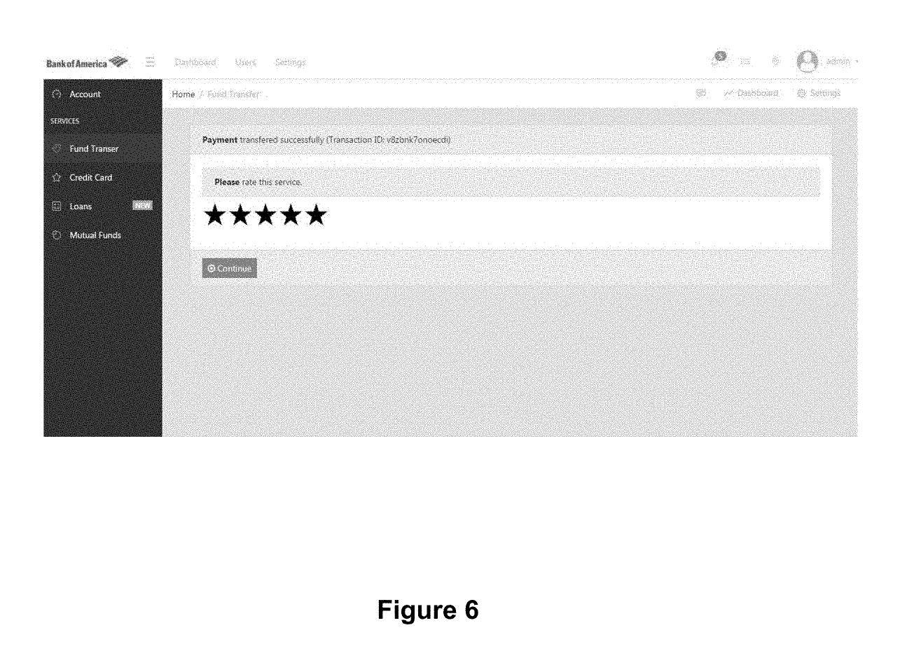

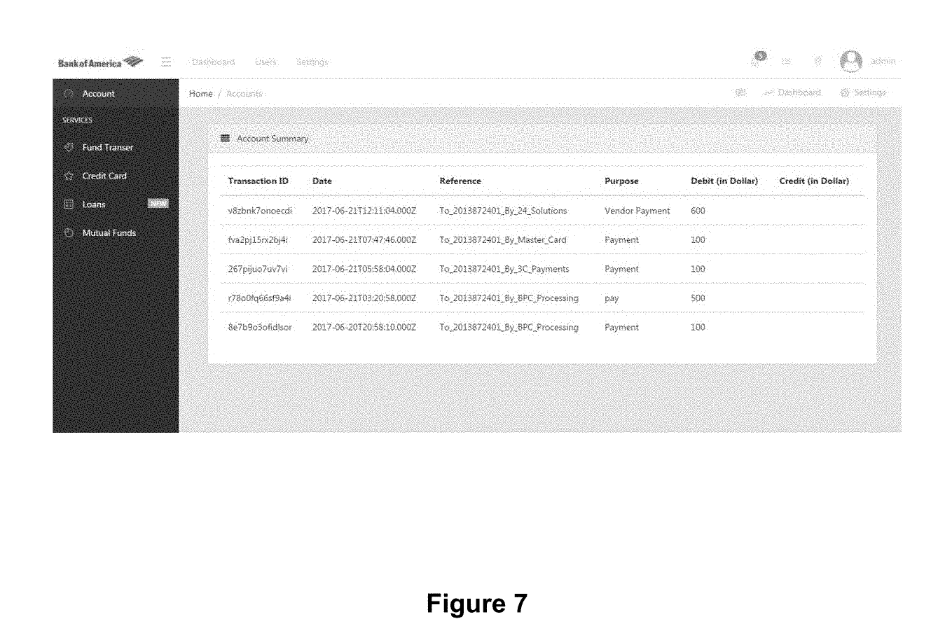

FIGS. 5 to 7 each show screen captures of a user interface provided by a banking portal maintained by the purchaser bank 104 of FIG. 1. FIG. 5 shows data fields through which the buyer 112 can enter details of the cross-border transaction, such as details of the seller 114 and the amount of funds to be sent, as explained in the above description with respect to step 404 of FIG. 4. FIG. 6 shows a feedback screen which is displayed after the buyer 112 clicks submit in step 404 of FIG. 4, allowing the buyer 112 to rate the cross-border payment experience. FIG. 7 shows an account summary page which displays a history of cross-border payments that the buyer 112 has made using their buyer bank account.

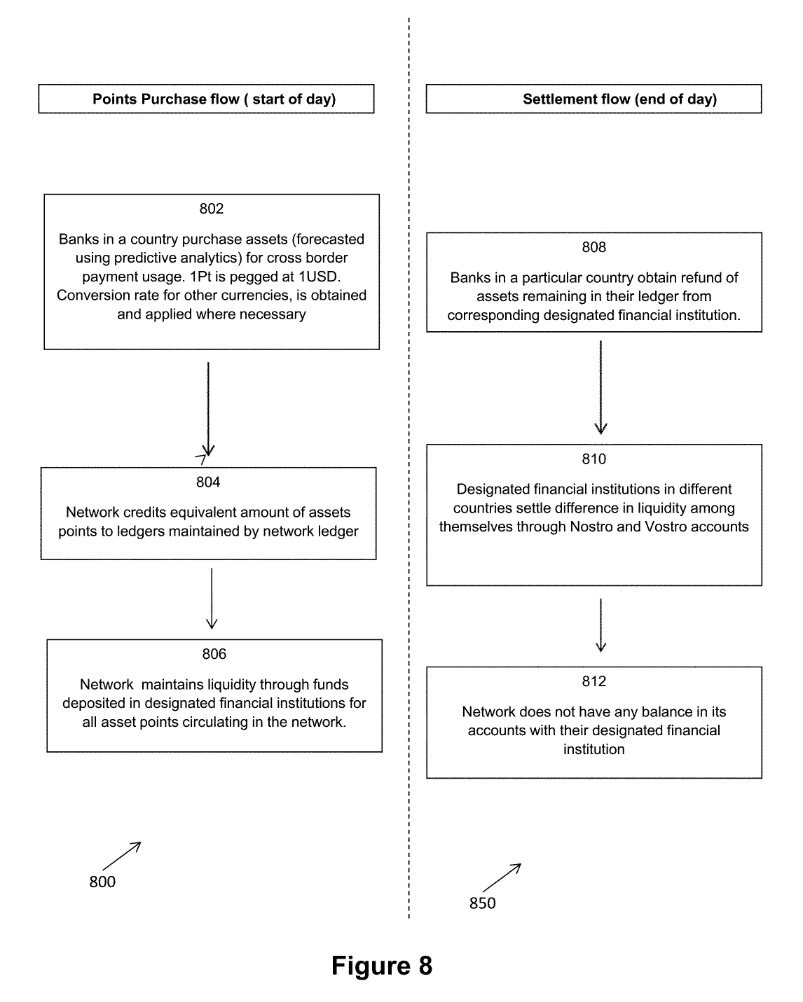

FIG. 8 shows a flow chart 800 of a sequence of steps that occurs in the system 100 of FIG. 1 at the start of a business trading cycle and a flow chart 850 of a sequence of steps that occurs in the system 100 of FIG. 1 at the end of a business trading cycle.

In step 802, banks 104, 106 will purchase assets used by the cross-border payment server 102 to conduct cross-border payment. If the bank 104, 106 is using a currency that is different from the one used by the assets, a currency exchange rate is applied to determine the number of assets that the fund amount in the bank currency can purchase.

In step 804, the cross-border payment server 102 will allocate the purchased assets into the respective ledger accounts 116, 118 that the banks 104, 106 have registered with the cross-border payment server 102.

In step 806, the funds used to purchase the assets are deposited in one or more designated financial institutions 108, 110. The deposited funds provide liquidity or act as a guarantee that the assets circulated by the cross-border payment server 102 has monetary value, which is drawn down upon request or at the end of a business trading cycle.

In step 808, each of the banks 104, 106 with an account registered in the ledger maintained by the cross-border payment server 102 will seek a refund for the assets held in their respective ledger account 116, 118. This refund is obtained through the cross-border payment server 102 purchasing the remaining assets in the ledger accounts 116, 118. The funds for this purchase are obtained from the funds deposited during the step 806 in the financial institution 108, 110 that is located in the same territory as the bank 104, 106 seeking the refund.

Step 810 occurs should the financial institution 108, 110 in one territory have insufficient liquidity or deposits to refund the purchase of the remaining assets in the ledger accounts 116, 118 registered to the banks 104, 106 in the same territory at the end of the business trading cycle. The financial institution 108, 110 that has insufficient funds will determine which other financial institutions (not shown) still has funds deposited from the step 806 and tap into these funds through a Nostro or Vostro account that the other financial institution maintains with the financial institution 108, 110 with insufficient funds.

The end of the business trading cycle completes in step 812 when the financial institutions 108, 110 no longer have a balance of funds from deposits made to guarantee cross-border transactions.

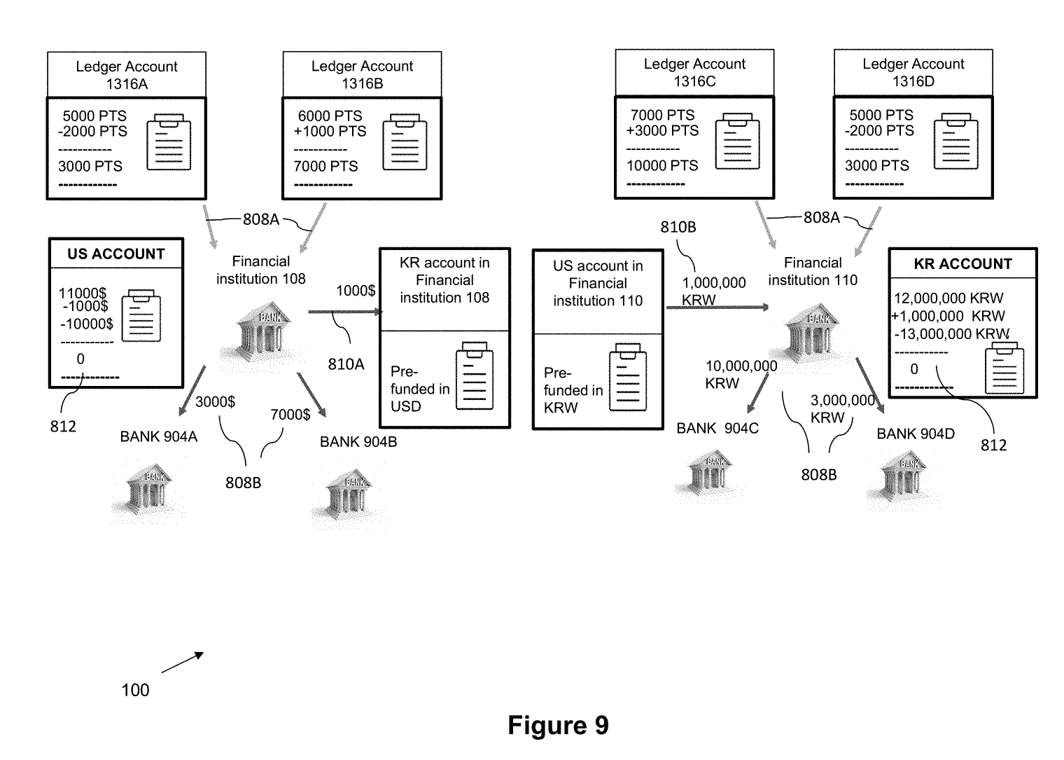

FIG. 9 shows a schematic of a flow of funds in the system 100 during the end of a business trading cycle. The cross-border payment server 102 is omitted in FIG. 9 for the sake of simplicity. However, the ledger accounts 1316A, 1316B, 1316C and 1316D that are maintained by the cross-border payment server are shown in FIG. 9.

The ledger accounts 1316A, 1316B, 1316C and 1316D are accounts registered in the ledger of the cross-border payment server 102 for the banks 904A, 904B, 904C and 904D respectively. FIG. 9 also shows the balance in each of the ledger accounts 1316A, 1316B, 1316C and 1316D at the end of the business trading cycle, along with the asset points that were traded in the last cross-border transaction. For the ledger account 1316A, its balance was 5,000 asset points before the last cross-border transaction being a payment of 2,000 asset points, resulting in a final balance of 3,000 asset points. For the ledger account 1316B, its balance was 6,000 asset points before the last cross-border transaction being a receipt of payment for 1,000 asset points, resulting in a final balance of 7,000 asset points. For the ledger account 1316C, its balance was 7,000 asset points before the last cross-border transaction being a receipt of payment for 3,000 asset points, resulting in a final balance of 10,000 asset points. For the ledger account 1316D, its balance was 5,000 asset points before the last cross-border transaction being a payment of 2,000 asset points, resulting in a final balance of 3,000 asset points.

As per step 808 of FIG. 8, the assets that remain in each of the ledger accounts 1316A, 1316B, 1316C and 1316D is purchased by the cross-border payment server 102. This is effected by each of the ledger accounts 1316A, 1316B, 1316C and 1316D sending a signal 808A providing details of its remaining balance to the respective financial institution 108, 110.

In the example shown in FIG. 9, the financial institution 108 has a deposit of 11,000 USD, which is more than sufficient to return USD 3,000 to the bank 904A and USD 7,000 to the bank 904B. However, the financial institution 110 has a deposit of 12,000,000 KRW, which is insufficient to return 10,000,000 KRW to the bank 904C and 3,000,000 KRW to the bank 904D.

As per step 810 of FIG. 8, the insufficient liquidity in the financial institution 110 is remedied by tapping into the surplus deposit in the financial institution 108. The financial institution 108 wires 810A its surplus of USD 1,000 to the financial institution 110, whereby the USD 1,000 is converted into 1,000,000 KRW when it is received 810B by the financial institution 110. The funds resulting from the sale of the remaining assets in the ledger accounts 1316A, 1316B, 1316C and 1316D are then returned 808B to the banks 904A, 904B, 904C and 904D respectively. At the end of the business trading cycle, the financial institutions 108, 110 no longer have a balance of funds from deposits made to guarantee cross-border transactions, as indicated from the reference numeral 812 in FIG. 9.

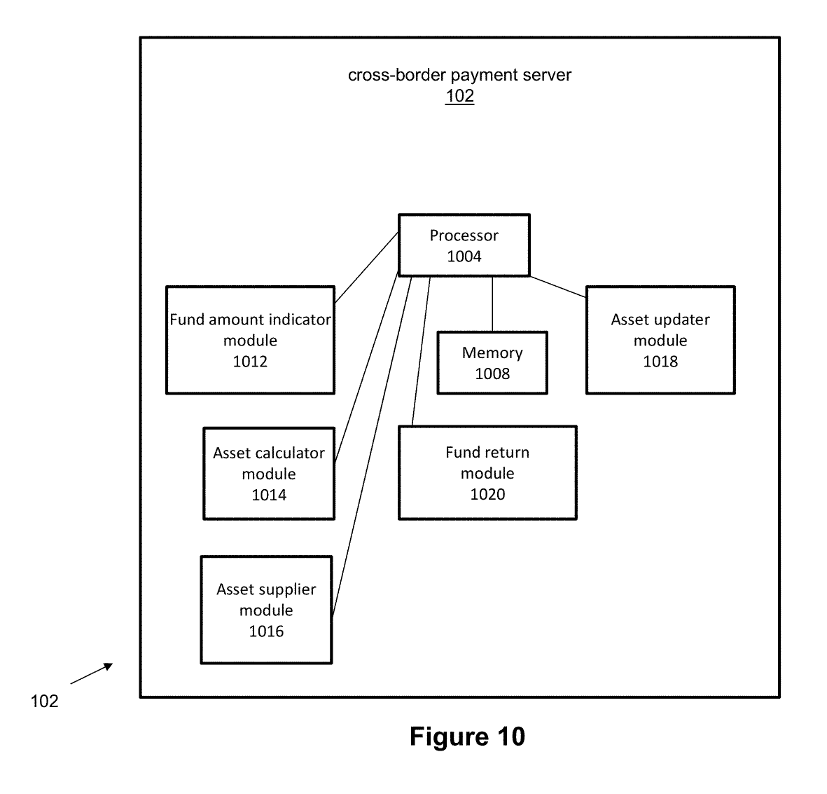

FIG. 10 provides a schematic diagram of functional modules present in the cross-border payment server 102 of FIG. 1.

The cross-border payment server 102 includes a processor 1004, a memory 1008, a fund amount indicator module 1012, an asset calculator module 1014, an asset supplier module 1016, an asset updater module 1018 and a fund return module 1020.

Each of the memory 508, the fund amount indicator module 1012, the asset calculator module 1014, the asset supplier module 1016, the asset updater module 1018 and the fund return module 1020 is coupled to the processor 504, so that their respective operations can be controlled by the processor 1004. The memory 1008 stores computer program code that the processor 1004 compiles to have each of the fund amount indicator module 1012, the asset calculator module 1014, the asset supplier module 1016, the asset updater module 1018 and the fund return module 1020 perform their respective functions.

Each of the fund amount indicator module 1012, the asset calculator module 1014, the asset supplier module 1016, the asset updater module 1018 and the fund return module 1020 can be implemented using one or more processors present in the cross-border payment server 102.

With reference to FIG. 1, the fund amount indicator module 1012 is configured to receive, from the purchaser ledger account 116 and the merchant ledger account 118, an indication of a fund amount to finance cross-border transactions. The purchaser ledger account 116 and the merchant ledger account 118 provide this indication from receiving a notification from the purchaser bank 104 and the merchant bank 106 respectively that there each of these banks 104, 106 are using the fund amount to purchase assets used by the cross-border payment server 102 to perform cross-border payment.

The asset calculator module 1014 is configured to calculate the assets purchased by the fund amount put up by each of the purchaser bank 104 and the merchant bank 106. If the asset is based on a currency that is different from the currency of the purchasing funds, the asset calculator module 104 will apply a foreign exchange rate when calculating the volume of assets that are purchased.

The asset supplier module 1016 is configured to supply the purchaser ledger account 116 and the merchant ledger account 118 with the purchased assets, by crediting each of these ledger accounts 116, 118 with the volume of assets calculated by the asset calculator module 1014.

The asset updater module 1018 is configured to update assets held in an account (e.g. the purchaser ledger account 116 and the merchant ledger account 118) resulting from assets traded during each cross-border transaction involving the account. This is done by crediting the account with the assets traded when the account receives payment in the cross-border transaction; or debiting the account with the assets traded when the account makes payment in the cross-border transaction.

The fund return module 1020 is configured to effect a return of funds in response to sale of the assets held in the account (e.g. the purchaser ledger account 116 and the merchant ledger account 118). This return of funds is typically effected upon request or at the end of a business trading cycle.

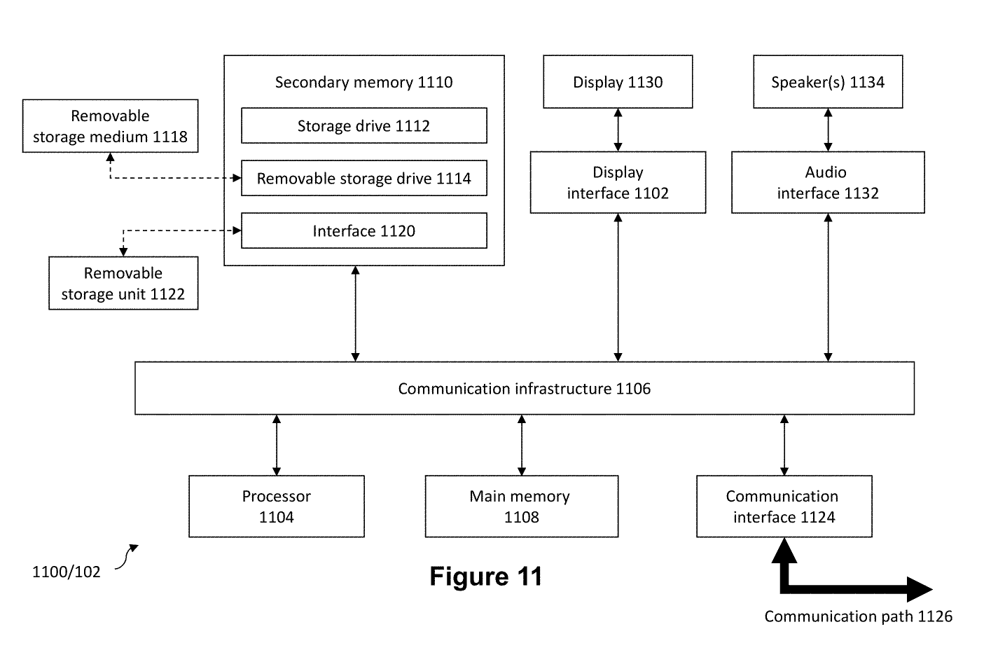

FIG. 11 shows a schematic diagram of further components in a computer device or computer system 1100 suitable for realizing the cross-border payment server 102 of FIG. 1. The following description of the computing device 1100 is provided by way of example only and is not intended to be limiting.

As shown in FIG. 11, the example computing device 1100 includes a processor 1104 for executing software routines. Although a single processor is shown for the sake of clarity, the computing device 1100 may also include a multi-processor system. The processor 1104 is connected to a communication infrastructure 1106 for communication with other components of the computing device 1100. The communication infrastructure 1106 may include, for example, a communications bus, cross-bar, or network. The processor 1104 is analogous to the processor 804 of FIG. 8. Thus the various modules of FIG. 8, the product availability detection module 810, the recipient/purchaser identification module 812, the bid module 814, the recipient response acquisition module 816 and the delivery rerouting module 818 send and receive data with the processor 1104 through the communication infrastructure 1106. These modules are not shown in FIG. 11 for the sake of simplicity.

The computing device 1100 further includes a main memory 1108, such as a random access memory (RAM), and a secondary memory 1110. The main memory 1108 is analogous to the memory 808 of FIG. 8. The secondary memory 1110 may include, for example, a hard disk drive 1112, which may be a hard disk drive, a solid state drive or a hybrid drive and/or a removable storage drive 1114, which may include a magnetic tape drive, an optical disk drive, a solid state storage drive (such as a USB flash drive, a flash memory device, a solid state drive or a memory card), or the like. The removable storage drive 1114 reads from and/or writes to a removable storage unit 1118 in a well-known manner. The removable storage medium 1118 may include magnetic tape, optical disk, non-volatile memory storage medium, or the like, which is read by and written to by removable storage drive 1114. As will be appreciated by persons skilled in the relevant art(s), the removable storage medium 1118 includes a computer readable storage medium having stored therein computer executable program code instructions and/or data.

In an alternative implementation, the secondary memory 1110 may additionally or alternatively include other similar means for allowing computer programs or other instructions to be loaded into the computing device 1100. Such means can include, for example, a removable storage unit 1122 and an interface 1120. Examples of a removable storage unit 1122 and interface 1120 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1122 and interface 1120 which allow software and data to be transferred from the removable storage unit 1122 to the computer system 1100.

The computing device 1100 also includes at least one communication interface 1124, which includes the input port 802 and the output port 804 of FIG. 8. The communication interface 1124 allows software and data to be transferred between computing device 1100 and external devices via a communication path 1126. In various embodiments, the communication interface 1124 permits data to be transferred between the computing device 1100 and a data communication network, such as a public data or private data communication network. The communication interface 1124 may be used to exchange data between different computing devices 1100 which such computing devices 1100 form part an interconnected computer network. Examples of a communication interface 1124 can include a modem, a network interface (such as an Ethernet card), a communication port (such as a serial, parallel, printer, GPIB, IEEE 1394, RJ45, USB), an antenna with associated circuitry and the like. The communication interface 1124 may be wired or may be wireless. Software and data transferred via the communication interface 1124 are in the form of signals which can be electronic, electromagnetic, optical or other signals capable of being received by communication interface 1124. These signals are provided to the communication interface via the communication path 1126.

As shown in FIG. 11, the computing device 1100 further includes a display interface 1102 which performs operations for rendering images to an associated display 1130 and an audio interface 1132 for performing operations for playing audio content via associated speaker(s) 1134.

As used herein, the term “computer program product” may refer, in part, to removable storage medium 1118, removable storage unit 1122, a hard disk installed in hard disk drive 1112, or a carrier wave carrying software over communication path 1126 (wireless link or cable) to communication interface 1124. Computer readable storage media refers to any non-transitory tangible storage medium that provides recorded instructions and/or data to the computing device 1100 for execution and/or processing. Examples of such storage media include magnetic tape, CD-ROM, DVD, Blu-ray™ Disc, a hard disk drive, a ROM or integrated circuit, a solid state drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1100. Examples of transitory or non-tangible computer readable transmission media that may also participate in the provision of software, application programs, instructions and/or data to the computing device 1100 include radio or infra-red transmission channels as well as a network connection to another computer or networked device, and the Internet or Intranets including e-mail transmissions and information recorded on Websites and the like.

The computer programs (also called computer program code) are stored in main memory 1108 and/or secondary memory 1110. Computer programs can also be received via the communication interface 1124. Such computer programs, when executed, enable the computing device 1100 to perform one or more features of embodiments discussed herein. In various embodiments, the computer programs, when executed, enable the processor 1104 to perform features of the above-described embodiments. Accordingly, such computer programs represent controllers of the computer system 1100.

Software may be stored in a computer program product and loaded into the computing device 1100 using the removable storage drive 1114, the hard disk drive 1112, or the interface 1120. Alternatively, the computer program product may be downloaded to the computer system 1100 over the communications path 1126. The software, when executed by the processor 1104, causes the computing device 1100 to perform functions of embodiments described herein.

It is to be understood that the embodiment of FIG. 11 is presented merely by way of example. Therefore, in some embodiments one or more features of the computing device 1100 may be omitted. Also, in some embodiments, one or more features of the computing device 1100 may be combined together. Additionally, in some embodiments, one or more features of the computing device 1100 may be split into one or more component parts.

In the case of FIG. 1, the memory (1110, 1118) contains computer program code, where the memory (1110, 1118) and the computer program code are configured to, with the processor 1104, cause the computing device 1100 to receive, from an account, an indication of a fund amount to finance cross-border transactions; calculate assets purchased by the fund amount; supply the account with the purchased assets; update the assets held in the account resulting from assets traded during each cross-border transaction involving the account; and effect a return of funds in response to sale of the assets held in the account. When doing so, the computing device 1100 communicates with other computer terminals through its communication interface 1124, which provides a communication port.

The computing device 1100 is further configured to, when updating the assets held in the account resulting from assets traded during each cross-border transaction involving the account: credit the account with the assets traded when the account receives payment in the cross-border transaction. Alternatively, the computing device 1100 is further configured to debit the account with the assets traded when the account makes payment in the cross-border transaction.

The computing device 1100 is further configured to, when calculating the assets purchased by the fund amount: apply a foreign exchange rate between a currency that the account uses and a currency in which the assets are based.

The computing device 1100 is further configured to deposit the fund amount to finance the cross-border transactions into one or more designated financial institutions.

The computing device 1100 is further configured to effect the return of funds upon receiving a request from the account or at an end of a business trading cycle.

The computing device 1100 is further configured to, when updating the assets held in the account resulting from assets traded during each cross-border transaction involving the account: update a balance of the assets held in the account. The balance is recorded in a ledger maintained by the computing device 1100. When the ledger is distributed across a system to which the computing device 1100 belongs, the computing device 1100 is further configured to update the balance of the assets held in the account from receiving a notification transmitted within the system.

The computing device 1100 is further configured to, before updating the assets held in the account resulting from assets traded during each cross-border transaction involving the account: keep a percentage of the assets traded during each of the cross-border transactions.

The computing device 1100 is programmed with the above functions as any one of its memory (1110, 1118) or removable memory (1118, 1122) provides a non-transitory computer readable medium for storing a program that when installed into the computer device 1100 configures the computer device 1100 to receive, from an account, an indication of a fund amount to finance cross-border transactions; calculate assets purchased by the fund amount; supply the account with the purchased assets; update the assets held in the account resulting from assets traded during each cross-border transaction involving the account; and effect a return of funds in response to sale of the assets held in the account.

Upon installation, the program allows the computing device 1100 to execute the flow charts shown in FIGS. 2 to 4 and 8.

With reference to FIG. 2, the step 202 sees a purchase of assets from the purchaser bank 104 and the merchant bank 106. This involves the computing device 1100 receiving, from either or both of the registered accounts of the purchaser bank 104 and the merchant bank 106, an indication of a fund amount to finance cross-border transactions.

The computing device 1100 then calculates the assets purchased by the fund amount from each of the accounts of the purchaser bank 104 and the merchant bank 106. In the step 204, the computing device 1100 supplies either or both of the accounts of the purchaser bank 104 and the merchant bank 106 with the purchased assets.

During the step 206, the computing device 1100 updates the assets held in either or both of the accounts of the purchaser bank 104 and the merchant bank 106 resulting from assets traded during each cross-border transaction involving these accounts.

During the step 208, the computing device 1100 effects a return of funds in response to sale of the assets held in either or both of the accounts of the purchaser bank 104 and the merchant bank 106.

Some portions of the above description are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on a computer effectively results in an apparatus that implements the steps of the preferred method.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A cross-border payment server comprising:
at least one processor;
at least one memory including computer program code;
the at least one memory and the computer program code configured to, with the at least one processor, cause the cross-border payment server at least to: that
receive, from an account, an indication of a fund amount to finance cross-border transactions;
calculate assets purchased by the fund amount;
supply the account with the purchased assets;
update the assets held in the account resulting from assets traded during each cross-border transaction involving the account; and
effect a return of funds in response to sale of the assets held in the account.

2. The cross-border payment server of claim 1, further configured to, when updating the assets held in the account resulting from assets traded during each cross-border transaction involving the account:
credit the account with the assets traded when the account receives payment in the cross-border transaction; or
debit the account with the assets traded when the account makes payment in the cross-border transaction.

3. The cross-border payment server of claim 1, further configured to, when calculating the assets purchased by the fund amount:
apply a foreign exchange rate between a currency that the account uses and a currency in which the assets are based.

4. The cross-border payment server of claim 1, further configured to deposit the fund amount to finance the cross-border transactions into one or more designated financial institutions.

5. The cross-border payment server of claim 1, further configured to effect the return of funds upon receiving a request from the account or at an end of a business trading cycle.

6. The cross-border payment server of claim 1, further configured to, when updating the assets held in the account resulting from assets traded during each cross-border transaction involving the account:
update a balance of the assets held in the account, the balance being recorded in a ledger maintained by the cross-border payment server.

7. The cross-border payment server of claim 6, wherein the ledger is distributed across a system to which the cross-border payment server belongs and wherein the cross-border payment server is further configured to update the balance of the assets held in the account from receiving a notification transmitted within the system.

8. The cross-border payment server of claim 1, further configured to, before updating the assets held in the account resulting from assets traded during each cross-border transaction involving the account:
keep a percentage of the assets traded during each of the cross-border transactions.

9. A method to effect cross-border payment, the method comprising:
receiving, from an account, an indication of a fund amount to finance cross-border transactions;
calculating assets purchased by the fund amount;
supplying the account with the purchased assets;
updating the assets held in the account resulting from assets traded during each cross-border transaction involving the account; and
effecting a return of funds in response to sale of the assets held in the account.

10. The method of claim 9, further comprising when updating the assets held in the account resulting from assets traded during each cross-border transaction involving the account:
crediting the account with the assets traded when the account receives payment in the cross-border transaction; or
debiting the account with the assets traded when the account makes payment in the cross-border transaction.

11. The method of claim 10, further comprising, when calculating the assets purchased by the fund amount:
applying a foreign exchange rate between a currency that the account uses and a currency in which the assets are based.

12. The method of claim 9, further comprising depositing the fund amount to finance the cross-border transactions into one or more designated financial institutions.

13. The method of claim 9, further comprising effecting the return of funds upon receiving a request from the account or at an end of a business trading cycle.

14. The method of claim 9 further comprising, when updating the assets held in the account resulting from assets traded during each cross-border transaction involving the account:
updating a balance of the assets held in the account, the balance being recorded in a ledger.

15. The method of claim 14, wherein the ledger is distributed across a system in which the method is performed and wherein the method further comprises updating the balance of the assets held in the account from receiving a notification transmitted within the system.

16. The method of claim 9, further comprising, before updating the assets held in the account resulting from assets traded during each cross-border transaction involving the account:
keeping a percentage of the assets traded during each of the cross-border transactions.

17. A non-transitory computer readable medium for storing a program that when installed into a computer device configures the computer device to
receive, from an account, an indication of a fund amount to finance cross-border transactions;
calculate assets purchased by the fund amount;
supply the account with the purchased assets;
update the assets held in the account resulting from assets traded during each cross-border transaction involving the account; and
effect a return of funds in response to sale of the assets held in the account.
